(19) United States
(12) Patent Application Publication
(10) Pub. No.: US 2020/0016969 A1
(43) Pub. Date: Jan. 16, 2020

(54) IMPROVED FOLDING DEVICE FOR COVERING BULKY MEMBERS

(71) Applicant: SIGEMILI S.R.L.S., Rovereto (IT)

(72) Inventor: Sergio Signori, Rovereto (IT)

(21) Appl. No.: 16/336,111

(22) PCT Filed: Sep. 26, 2017
(86) PCT No.: PCT/IB2017/055836

§ 371 Date: Mar. 24, 2019

(30) Foreign Application Priority Data
Sep. 29, 2016 (IT) UA2016A006934

(51) Int. Cl. B60J 11/04; B32B 5/02; B32B 3/10; H02S 30/20

(52) U.S. Cl. CPC B60J 11/04; B32B 5/02; B32B 3/10; H02S 30/20; B32B 2571/00; B32B 2307/7265; B32B 2307/304; B32B 2307/416; B32B 2307/584

(57) ABSTRACT

An improved folding device (1; 50) for the covering of bulky bodies comprising a multilayer element (2; 51) composed of a plurality of multilayer covering sections (3) being spaced, distinct and independent from each other, constantly kept in position by locking means (4) arranged in such a manner, as to define between the multilayer covering sections (3), interstitial longitudinal discharge recesses (5) suitable to allow the mutual rotation of the multilayer covering sections (3) along a plurality of longitudinal lines (K), parallel to each other, and a plurality of latitudinal lines (W), parallel to each other, orthogonal to and crossing the longitudinal lines (K), in such a way that the multilayer element (2; 51) takes on an operating condition suitable to cover at least the most critical and sensitive points of a bulky body to protect it from invasive atmospheric agents, wherein the multilayer covering sections (3) are mutually substantially coplanar and positioned side by side along the first longitudinal directions (X) parallel to each other and along second longitudinal directions (Y) parallel to each other, orthogonal to the first longitudinal directions (X), and a non-operational condition suitable for storing the multilayer element (2; 51), in which the multilayer covering sections (3) are folded one on top of the other according to a predefined sequence along the longitudinal lines (K) and latitudinal lines (W), in such a way as that the inner face of the multilayer covering sections (3), that are progressively affected by the folding process, be substantially positioned adjacent to and facing the inner face of the multilayer covering sections (3) on which they are folded and that the multilayer covering sections (3) be thus stacked and superimposed on to each other thus forming an ordered and compact package (6).

### TECHNICAL FIELD OF APPLICATION

The present invention relates to an improved device, that can be neatly folded and packed, intended—when fully open, deployed and ready to use—to cover bulky bodies, which are typically though not exclusively, cars: the main task of the improved folding device according to the invention, when in its operational condition, is to protect the body or bulky object from harsh weather or, more generally, by the more or less accentuated abrasive action of serious weather conditions, such as hail, scorching sun, rain, pollution, dust, snow, sleet, chemical fall-out and the like.

So, therefore, the improved device according to the invention takes on two possible conditions: a first non-operational condition (rest position or do not use), when it is folded in an orderly manner onto itself in such a way as to be well-packaged, with its component elements neatly stacked one on top of the other and take up the least possible space; a second operational position and condition (rest position or in use) when it is totally deployed, positioned and open and covers, protects or shelters the bulky object.

There are currently two categories of covering devices of the type herein considered, that can be used to achieve the goal of protecting or sheltering the bulky object: shells and covers used to temporary cover the object.

The main difference between the shells and covers consists in the fact that the first are not laid in contact with the object, whereas the second must be in close contact with the surface to be covered.

Conventionally, a covering shell device used to cover bulky bodies that take up a lot of space (such as cars, caravans, motorcycles and so on) is commonly known as a garage or fixed portico (sometimes it may be extended or has a modular structure) that, in its operational condition, has a box-like configuration, often in the form of a tunnel or a snail shell.

There are also portable covering devices having a rigid structure used as a roof or veranda or portico.

In addition to that, the prior art shows fixed or folding covering devices, embedded into bulky object, destined to be covered by mechanisms and handling systems envisaging a roof or a veranda over the object in which they are embedded.

The second category of covering devices that has been defined above, as it has already been highlighted, comprises the temporary covering devices, which—in their operating conditions—are positioned in direct contact with the surface of the bulky object to be covered and protected: these covering devices, as normally and functionally provided, are well known, being constituted by a simple sheet of fabric or other material that remains free and without particular constraints or gears, and are applied on top of the object to be protected.

The covering devices of this particular type—which the present invention is specifically focused on—are often provided with special design precautions to allow them to be steadily fixed, although it is still a temporary and removable fixing, to the underlying bulky object or have different conformations, in relation to the object for which they are intended.

More in detail, in the context of the type of those covering devices having a well-developed design concept that, in their operating condition, are positioned adjacent to the bulky object to be covered and protected, what can be observed, are solutions comprising a sheet which, by means of mechanisms and handling systems embedded into the bulky object itself, unfolds and fully opens and thus completely covers the object.

On the other hand, in the present state of the art, covering devices are found, which are intended to come into direct contact with the surface of the bulky object to be covered (they can be defined—this must be reiterated—as temporary covering devices) that are not embedded into the object itself: these covering devices, which are totally independent and separate from the bulky object they can be easily removed from, are the main object of the present invention.

The specificity of these covering devices is their ancillary elements with which they are provided, and are useful to facilitate their use in terms of handling, wrapping and unwrapping or folding before and in view of the subsequent use and the storage or positioning after use.

Moreover, since the present invention hypothetically also relates to a support (as an extension of the term sheet) for photovoltaic panels, what must be pointed out is that many fixed, mobile or even adjustable—with respect to the car—devices do exist within the known art and they are able to support photovoltaic panels.

Even in this case two support categories are identified: the functional supports used for photovoltaic systems and the supports that integrate photovoltaic systems into existing structures, such as structures embedded onto the roofs of residential buildings where photovoltaic panels replace the traditional roof and are called embedded systems.

### STATE OF THE ART

Referring to the state of the art, many reference publications can be identified for each type of covering sheet identified in the previous disclosure of the technical field of application.

In particular, as for the mostly fixed coverings, such as a car sheltering garage or portico, the patent CN204960476 (U) is mentioned.

As for the partially movable or portable hard covers that can be positioned above or around the bulky object to be covered and protected, that are, however, at least partly associated to or in contact with it, the patent publications U.S. Pat. Nos. 3,600,866 A, 5,984,401 A and 6,964,447 B2 are mentioned.

As for the covers that are aggregated or embedded into the bulky object for which they are intended in operational conditions, that are installable and removable by means of mechanisms and handling systems, the patent publications U.S. Pat. Nos. 7,562,928 B1, 8,070,211 B2, 8,651,555 B2 and 8,419,107 B2 are herein mentioned.

As for the temporary covering devices, i.e. those devices which cover the surface of the bulky object by coming into direct contact with it and starting from simple covers—comprising a free fabric sheet often provided with coupling hooks for the stable coupling, but that can be removed from the bulky object itself—examples of the state of the art comes from the following patent publications: U.S. Pat. Nos. 5,791,361 A, 6,918,626 B2, 6,997,503 B2, 7,255,386 B1, 7,337,793 B2, 7,458,630 B1, 8,764,097 B2, 4,858,985 A and 8,905,459 B1.

In the same category, but with mechanisms embedded into the bulky object for which they are intended, and which are hidden when not in use, what is appropriate is mentioning the following patent publications U.S. Pat. Nos. 5,516,181 A, 5,762,393 A, 6,371,144 B1, 6,916,043 B2, 7,090,282 B2, 7,137,661 B2, 7,464,982 B1, 8,684,444 B2, 8,910,997 B2.

Finally, as for the covering devices provided with suitable accessories intended to ease their generic handling, as well as their mounting and unmounting with respect to the bulky object for which they are intended, the following patent publications are herein highlighted: U.S. Pat. Nos. 4,858,985 A, 4,889,171 A, 4,951,993 A, 5,167,267 A, 5,413,396 A, 6,318,426 B1, 6,997,503 B2 and 8,608,223 B2.

Specific examples of devices for covering cars, which are mentioned purely by way of information, are in particular known from the above-mentioned patent documents U.S. Pat. Nos. 6,997,503 B2, 6,318,426 B1, 5,413,396 A, 4,951,993 A, as well as the patent documents U.S. Pat. Nos. 6,318,393 B1, 5,429,406 A and 5,890,525 A.

In the light of the above detailed state of the art, it is therefore clear that there are many covering devices intended for bulky bodies, typically cars, which however are not able to meet the aims according to the present invention as they will be shortly specified; covering devices of the known type are substantially and basically classified into three main types:
a) coverings which are suitable to be installed in an embedded and permanent way into bulky bodies, for example a car, for whose coverage and protection they were primarily designed: these coverings require specific, definitive, fixed and significant design precautions related to the bulky bodies on which they are installed, in a permanent and unmovable manner anyway, and sometimes having a negative impact on the aesthetic appearance of the objects;
b) fixed coverings that cannot be stored or transported in the same bulky object: they can hardly be considered transportable objects because of their considerable size or because they are not easily installed and are thus totally inadequate to cover and protect the object, typically a vehicle, when the latter, while in use, is parked away from the area where the fixed covering that cannot be transported is installed;
c) storable and light coverings, which need—however and on the basis of their inherent design and structure—a certain amount of time and work to be effectively mounted, or just laid on to the bulky object as protection layers, to the point that more than one person is often—or even always—needed to do the job.

In any case, however, as it can be clearly inferred from the above-mentioned documents of the prior art, these are structurally complex solutions, which therefore cannot be used on a daily basis and right away, in any place, and cannot meet all needs and deal with every eventuality.

Some of these design solutions can also be regarded as simple coverings that are used to just shelter bulky bodies, often just cars, against direct sunlight, but not against heat in general or frost or hail; other covering devices of the known type are also intended to also shelter bulky bodies from hail and frost, but it is very difficult to move them, so that they can be considered useful and usable only for storage of the bulky object, or as permanent parking areas in a specific place, the one where they are permanently installed.

The critical nature of this aspect is strongly highlighted by taking into consideration that category of covering devices that have been mentioned at the above mentioned point a) (coverings involving permanent changes of the bulky bodies to which they are applied, for example, vehicles), because, it is clear that the design changes that they cause, cannot be performed by any end user at any time and, if it happens, this means, however, that the vehicle cannot be reconfigured back to its original version, and this might entail drawbacks in case of future changed needs or aesthetic expectations, concerning the vehicle, by the rightful owner.

### OBJECTS AND SUMMARY OF THE INVENTION

Therefore, being aware of the above-mentioned drawbacks of the prior art, and starting from the latter, the present invention wants to find an adequate solution.

In particular, the main object according to the present invention is to make an improved folding device aimed at covering a bulky object, typically a motor vehicle, that can be installed and removed in a practical, quick and effective way even by a single user without any specific technical skill in this regard.

The second object of the invention is to provide an improved folding device for covering any bulky object, such as a car, which can be easily made movable and storable, even in the boot of the car, and ready to use in just a few minutes.

Another object according to the present invention is creating an improved folding device that, by means of just one device, is suitable to cover any object, for example a motor vehicle, and, at the same time, is suitable to protect the bulky object it is associated to, from:
Any damage usually caused by exposure to sunlight;
High temperatures due to exposure to sunlight;
The formation of ice on the surface of the bulky object, such as a company car, which notoriously runs such a risk more often that a car for private use, since it is always parked outdoors, when not in use, and even more particularly on the glass surfaces of the car, which is a problematic and annoying phenomenon that worsens during winter, or at least in those places where the temperatures, especially at night, are accompanied by condensate formation, which causes serious drawbacks to the users of these vehicles while using it;
Hail;
Wear due to prolonged exposure to atmospheric agents, especially in those places where the salinity in the air can attack and even corrode the objects and the body.

The creation of art improved folding device for covering bulky bodies, in particular a motor vehicle, is a further object according to the present invention, that, when it is in its non-operational condition, can be stored in a more orderly and effective way than the similar equivalent devices of the known type, and, if compared to the former, takes up much less space.

An additional object according to the present invention is to provide an improved folding device for covering the bulky bodies, especially a motor vehicle, that, when it is not in use, can be stored without suffering from and causing any damage, even if it is still wet or soaked because of the rain that fell on to it, when it is stored away after having been dismounted from the bulky object.

Last but not least, another object according to the present invention is to provide an improved folding device for covering bulky and three-dimensional bodies, especially a motor vehicle, which does not add up to the volume of the vehicle itself when it is applied onto it and from which it is cannot be accidentally and fortuitously separated—therefore in an uncontrolled manner—when in its operational condition.

Said objects are achieved by means of an improved folding device for covering bulky and three-dimensional bodies as in the appended claim 1, to which reference is made for the sake of brevity.

Other detailed technical characteristics of the improved folding device for covering bulky bodies of the invention are set forth in the corresponding dependent claims.

The aforesaid claims, hereinafter specifically and concretely defined, are deemed as an integral part of the present description.

According to the present invention, an improved folding device is herein shown, used as a general covering, suitable to protect a bulky body (which is generally a car) against light, heat, ice, condensation, harsh weather and severe atmospheric agents, comprising a plurality of semi-rigid multilayer covering sections, coated in fabric and stuffed with composite material, which is at least partly plastic, in such a way as to form folding longitudinal and latitudinal portions to ease the orderly folding and storage of the improved folding covering device by stacking it, as well as to ease any handling, application, installation, removal and unfolding operations, especially in relation to its application position, when it is used to cover the bulky body.

Furthermore, according to the present invention, the folding sections meet a predetermined folding order (and obviously an unfolding order), on condition that the measures of the folding sections provide for a suitable and studied combination of the size of the multilayer sections of the cover and the spaces (or interstitial recesses) between the multilayer sections, designed in such a way as to take into account the level of bending in the longitudinal layer and the preceding latitudinal layer.

In the invention, the spaces between the tiles of the covering device ensure that the folded sections overlap, both according to latitude and longitude, in such a way as to create an orderly stackable unit, such as a book, which is easy to handle and store.

Moreover, according to a preferred aspect, even though it is not binding, according to the present invention, the improved folding device for covering bulky bodies, when properly and appropriately folded onto itself, is storable in a watertight box that can be sold or supplied with the device itself, inside which it is therefore possible to store in an orderly manner the folded covering device even if it is wet because of the rain or wet weather, without causing damage to structures (which generally belong to the same bulky body), wherein the covering device of the invention will be positioned immediately after use.

In addition, according to the present invention, the padding of the multilayer covering sections of the improved folding device for covering bulky bodies has the function of protecting the latter from shocks, in general, and in particular those caused by hail, by directly forming a sort of shield, or indirectly by maintaining the tension of the material to be found in the interstitial longitudinal discharge recesses between the multilayer covering sections.

Moreover, by means of the locking means which keep the multilayer sections intended for covering and damping in position, what is possible, during production, is changing, according to the requirements and needs of the market, the size of the improved folding device used for covering the bulky bodies according to the present invention, making it suitable to protect the fundamental and most sensitive parts, but also those parts of the bulky body that are not so much at risk from hail, exposure to sun rays and, in general, from severe atmospheric agents: this possibility makes the improved folding device for covering bulky bodies according to the present invention adaptable to the different covering and protecting needs, be they partial or complete, to meet the needs of the final user and to ease its use.

Moreover, according to a further preferred aspect, but which is not an essential aspect, according to the present invention, a system for fixing and clamping the improved folding device is envisaged, the device being used to cover bulky bodies, obtained for example by means of a steel cord or tear proof fabric going through the entire width of the device. It is applied to the portion (generally below it) of the covering device that is intended to cover the main part (for example the convertible top or hood or the roof of a car) of the bulky body and configured in such a way as to:
Enter the cabin of the car by passing through the gap existing between the bodywork and the doors (usually only the front ones), and by interfering with the corresponding gaskets, and be combined with the engagement grips that are normally intended to receive the locking pins coupled to the ends of the seat belts fitted to the seat of the driver and the front passenger seat;
Its end is simply constituted by a solid body that prevents the steel cable from slipping out of the doors of the vehicle, when the latter is closed.

The embodiment according to the invention envisages that the improved folding device for covering bulky bodies be able to cover a hood of a car by first laying down the multilayer element, in its configuration corresponding to the non-operational condition in which all its multilayer covering sections are stacked in a package one on top of the other, in the central end part of the car hood and then opening such multilayer sections in sequence starting from this position up to cover the desired parts of the motor vehicle. The invention therefore provides, an improved folding device for covering bulky bodies to protect them against light, the heat of the scorching sun, ice, harsh weather, severe atmospheric agents, pollution and so forth: it is structured according to a plurality of multilayer covering sections that are assembled together by means of locking means, externally made of fabric and internally padded with semi-rigid and thermally insulating tiles (tiles or flaps).

The improved folding device for covering bulky bodies according to the invention is configured in such a way as to be easily folded in the longitudinal and latitudinal way, according to a predetermined folding sequence, and suitably designed: in particular, according to the main longitudinal development of the multilayer element of the improved folding device of the invention (coinciding with the main longitudinal development of the body bulky to be protected), the folding sequence is performed according to an ascending order of the length of each one of the multilayer covering sections.

The multilayer covering sections of the invention covering the improved folding device for covering bulky bodies are stacked one on top of the other in a package in such a way as to create—when such an improved folding device is closed or is in its non-operational condition—a squared object that is easily stored inside a box, which is generally permanently integrated to a multilayer reference section—the largest one—from the bottom. Such a box can be appropriately and effectively stored in a car boot or anywhere in general, fully preserving the structural and functional integrity of the improved device of the invention when not in use.

The improved folding device of the invention can be used to cover any three-dimensional body of specific dimensions, such as a motor vehicle or a stored boat, to protect it from the high temperatures of the scorching sun to which it is exposed, frost and, in general, low temperatures due to harsh weather conditions, hail, heavy rain, snow, wear due to prolonged exposure to atmospheric agents, dust, pollution, chemical fall-out and so forth.

The composition of the improved folding device of the invention, which provides a multilayer element, can vary in function of the characteristics of the bulky body to be covered and protected and of the envisaged primary use, as well as the type of semi-rigid plastic tiles belonging to each one of the multilayer covering sections.

The composition of the improved folding device for covering bulky bodies is mainly and preferably the following: a lower layer of anti-scratch and water repellent soft fabric, intended to be in contact with the bulky body to be protected (for example the bodywork and car windows), the semi-rigid tiles made of insulating material suitable for shielding the bulky body from the above mentioned harsh weather conditions and for adapting to the shape of the bulky body to be protected, an intermediate layer of thermally insulating material (for example, polyethylene fabric) and a top layer of water repellent reflective fabric (whose colour might be similar to the aluminium's).

The above-mentioned layers are firmly held together through locking means, such as sewing thread or heat sealing, which define the joint areas (or longitudinal interstitial discharge recesses) which allow, in turn, the longitudinal and latitudinal folding of multilayer covering sections.

The longitudinal and latitudinal lines—defined by the longitudinal interstitial discharge recesses—along which the latitudinal folding of the multilayer covering sections occurs, are aligned in such a way that, when the user rotates one single covering section to fold the device, even the other covering sections that are aligned to it, according to latitude or longitude, are rotated and bent over those immediately adjacent.

The differences between the multilayer covering sections—coinciding with the width of each one of the longitudinal interstitial discharge recesses—along each entire longitudinal line or along each entire latitudinal line of the multilayer element which distinguishes the improved folding device of the invention, is configured in such a manner as to take into account the thickness resulting from the level of the folding of the multilayer covering sections adjacent to it and obtained at that folding point, in order to allow for further folding of each respective folding section and their compact packing.

### SHORT DESCRIPTION OF THE FIGURES

The said objects and advantages, as well as others which will emerge in the continuation of the present exposure, will be made clearer by the following description, related to the preferred embodiments of the improved folding device covering bulky bodies, object of the invention, and disclosed by way of example and in an illustrative, but non-limiting way, with reference to the accompanying drawing in which:

FIG. 1 is an axonometric view of the improved folding device for the covering of bulky and three-dimensional bodies of the invention, in the open, stretched out, unfolded, operational or in use condition;

FIG. 2 is an exploded simplified axonometric view of the improved folding device for covering the bulky bodies of FIG. 1, shown to illustrate at least in part the structural composition;

FIG. 3 is an axonometric view of the improved folding device for covering the bulky bodies of FIG. 1 showing the operating sequence according to which it goes from the open, stretched out, deployed or in use condition to the closed, packed, folded, non-operational or not-in-use condition;

FIG. 4 is an axonometric view of the improved folding device for covering the bulky bodies of FIG. 1 in the operational condition and application position, and positioned on top of a car;

FIG. 5 is a top plan view of the improved folding device for covering the bulky bodies of FIG. 1 in the operational condition, complete with suitable fittings for the type of car of FIG. 4;

FIG. 6 is an axonometric view of a first possible variant embodiment of the improved folding device for covering the bulky bodies of FIG. 1;

FIG. 7 is an axonometric view of the improved folding device for covering the bulky bodies of FIG. 5 in the operational condition and application position, and positioned on top of a car;

### DETAILED DESCRIPTION OF PREFERRED EMBODIMENTS OF THE INVENTION

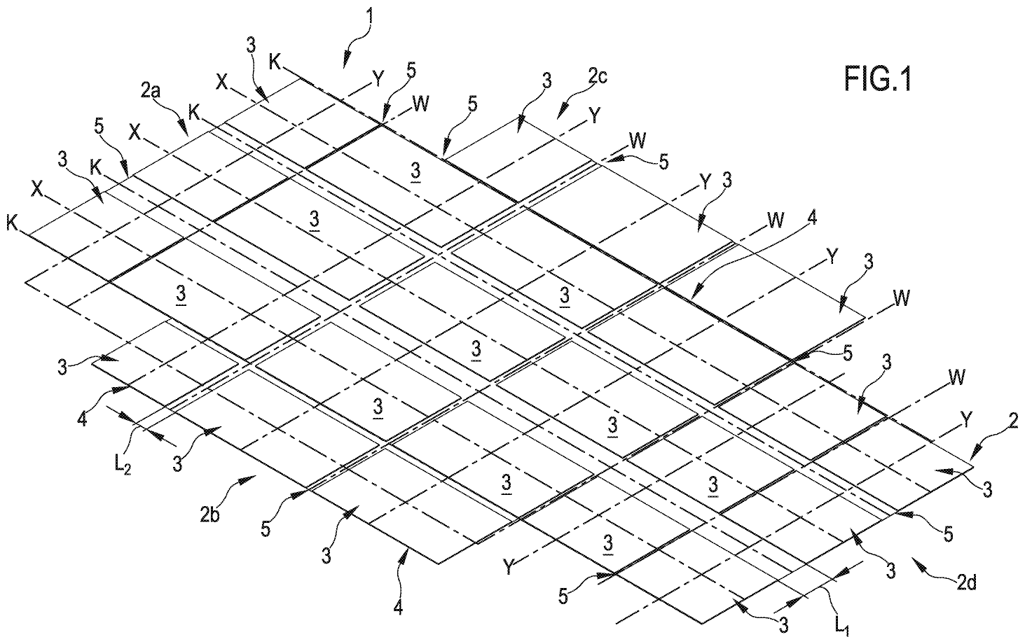

The improved folding device of the invention, intended to cover bulky and three-dimensional bodies, such as—though not in a limiting way—a car A, is illustrated by means of a first embodiment in FIG. 1, where it is generally designated by the reference numeral 1.

In accordance with the invention, as it can be seen in FIG. 1, the improved folding device 1 comprises a multilayer element 2 composed of a plurality of multilayer covering sections 3 that are spaced, distinct and independent one from the other, and kept steadily in position by locking means, generally designated by the reference numeral 4, arranged or applied in such a manner as to define between the multilayer covering sections 3 a series of longitudinal interstitial discharge recesses 5 suitable to allow the mutual rotation of the multilayer covering sections 3 along a plurality of longitudinal lines K parallel to each other and a plurality of latitudinal lines W parallel to each other and orthogonal to and crossing the longitudinal lines K, in such a way that the multilayer element 2 takes on:
an operational condition suitable to cover the bulky body A—or at least its most critical, sensitive points which are most subject to damage, even irreversible damage (for example the front window T, the hood C, the side windows F and the rear window L of the car)—to protect it against invasive atmospheric agents (such as hail and scorching sun), wherein the multilayer covering sections 3 are mutually substantially coplanar and placed side by side along the first longitudinal directions X, parallel to each other, and along second longitudinal directions Y parallel and orthogonal to the first longitudinal directions X;
a non-operational condition suitable for storing the multilayer element 2, wherein the multilayer covering sections 3 are neatly folded one on top of the other according to a predefined sequence along the longitudinal lines K and the latitudinal lines W, in such a way that the inner face of the multilayer covering sections 3, which are progressively affected by folding, is substantially adjacent to and facing the inner face of the multilayer covering sections 3 on which they are folded and that the multilayer covering sections 3 are thus stacked one upon the other and overlap to create an orderly and compact package 6, taking up minimum space, that determines, consequently, the saving of space when storing it and easy handling.

In particular, the width of each one of the longitudinal interstitial discharge recesses 5 positioned along one of the longitudinal lines K or one of the latitudinal lines W is no less than the sum of the thicknesses of the multilayer covering sections 3 adjacent thereto and simultaneously folded again by the user by rotation around the longitudinal lines K or the latitudinal lines W.

FIG. 1 also shows that the longitudinal interstitial discharge recesses 3 (in this specific case, in a preferred manner, defined only in their upper surface 2d of the multilayer element 2) positioned in one of the longitudinal lines K or in one of the latitudinal lines W, conveniently have, thanks to the precision of the application system of the locking means 4, the same width L₁ o L₂.

Moreover, from the point of view of the constructional design of the multilayer element 2 of the improved folding device 1 of the invention, the length of one of the multilayer covering sections 3, taken as reference, is shorter than the length of one of the multilayer covering sections 3 on which such multilayer covering section 3, taken as a reference, is directly folded along the first longitudinal directions X.

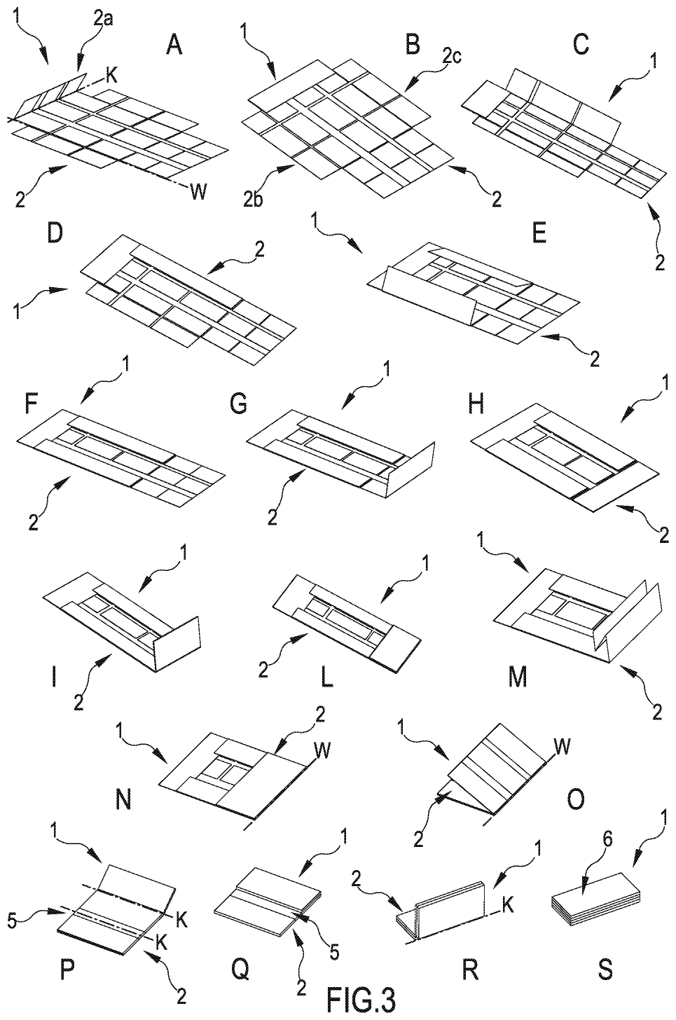

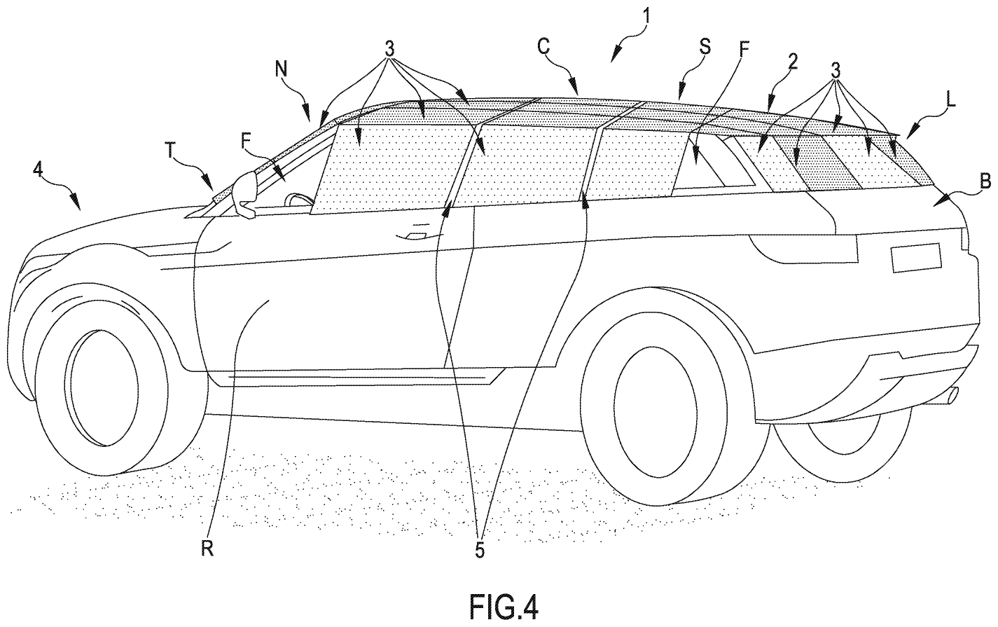

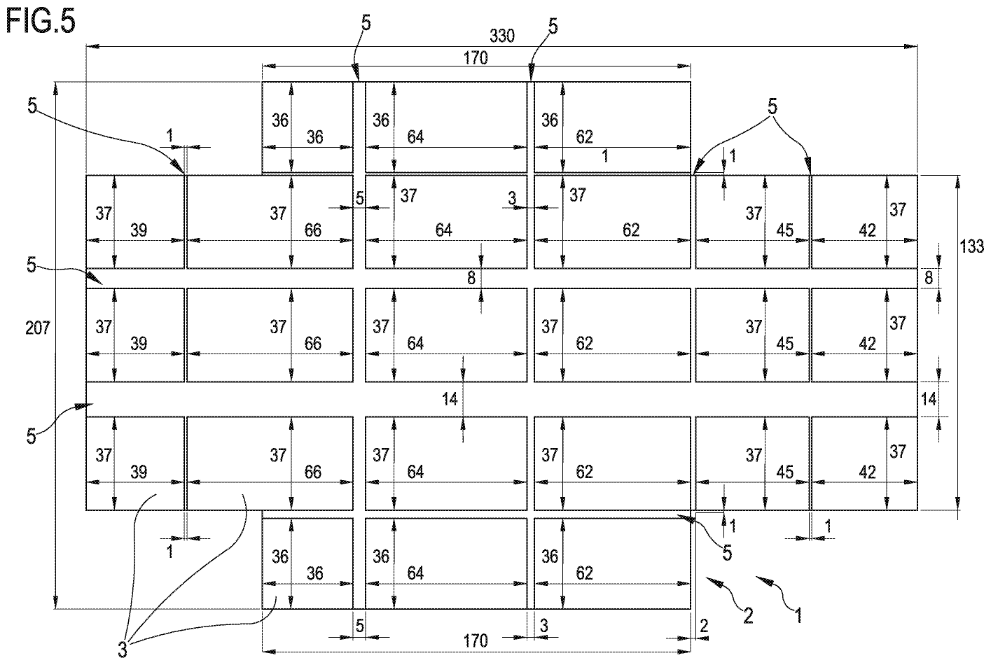

What must be also pointed out is that, according to the main longitudinal development of the multilayer element 2 in its operational condition, such direction of development coinciding with the direction of the main longitudinal development of the bulky and three-dimensional body A that is to be protected, the folding sequence of the multilayer covering sections 3 occurs according to an ascending order of the length of each one of the multilayer covering sections 3, as it will be better explained below thanks to FIGS. 3 and 4 and, in a more detailed manner, thanks to FIG. 5.

Even more in detail, in the non-operational condition of the multilayer element 2:
Each one of the multilayer covering sections 3 positioned along one of the first longitudinal directions X is fully comprised within the space of one of the multilayer covering sections 3 adjacent thereto, along said first longitudinal direction X, it is folded above it, and facing and substantially positioned adjacent to it;
Each one of the multilayer covering sections 3 positioned along one of the second longitudinal directions Y is fully comprised within the space of one of the multilayer covering sections 3 adjacent thereto, along said second longitudinal direction Y, it is folded above it, and facing and substantially positioned adjacent to it;

Moreover, the multilayer covering sections 3 positioned along one of the first longitudinal directions X or along one of the second longitudinal directions Y are movable in a way that is integral between them during folding, from the non-operational condition to the operational condition and vice versa, and obtained by rotation of the multilayer covering sections 3 around one of longitudinal lines K or one of the latitudinal lines W.

These constructional aspects can be clearly seen in FIG. 5 that, even if it refers to the improved folding device 1, which is intended specifically for covering a vehicle A (which is highly widespread in the actual car market) of the type shown in FIG. 4, highlights thanks to its measures—it should be noted that this is mentioned only in an explanatory and not limited way—the technical principle underlying the present invention.

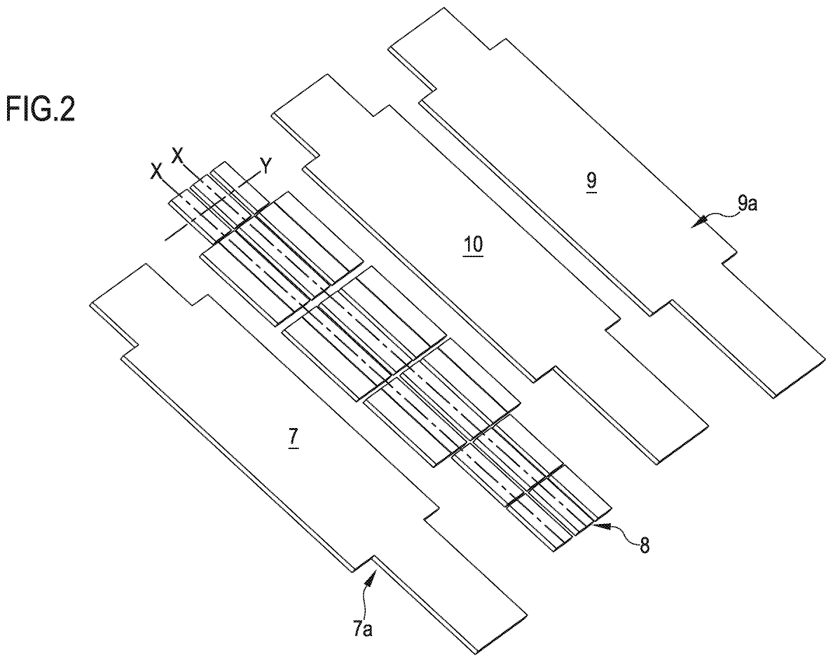

According to the preferred embodiment of the invention herein described, as it can be inferred by observing FIG. 2, the multilayer element 2 comprises:
A lower layer 7 made of soft anti-scratch and water-repellent fabric, provided with a lower face 7a adapted to come into contact with the bulky body A to be protected (for example the folding top—or folding hood—and the car windows);
A plurality of semi-rigid tiles 8 used for padding, positioned above the bottom layer 7 and made of insulating material, suitable to shield the bulky body A against severe atmospheric agents and to adapt to the shape of the bulky body A to be protected;
An upper layer 9 made of water-repellent, reflective fabric positioned above the semi-rigid padding tiles 8 and provided with an upper face 9a facing outwards and suitable to be damaged or affected by severe atmospheric agents,
   the lower layer 7, the semi-rigid padding tiles 8 and the upper layer 9 being mutually coupled by the locking means 4.

Preferably but not necessarily, the multilayer element 2 comprises a laminar layer of thermally insulating material 10, made for example of polyethylene fabric, positioned between the semi-rigid padding tiles 8 and the upper layer 9 and made integral with the lower layer 7, the semi-rigid tiles 8 and the upper layer 9 again by the locking means 4, that are schematically shown in a schematic and simplified manner in FIG. 1.

More in detail, each one of the semi-rigid padding tiles 8—which constitute the core of each multilayer covering section 3—preferably has a rectangular shape and is composed of a lower reinforcement substrate (not shown and made, for example, of an aluminium sheet), an amorphous intermediate layer (not represented and made, for example, of a parallelepiped shape of rock wool or glass wool) and a top reinforcement layer (also not shown) having a thickness which is substantially equal to that of the lower reinforcement substrate.

In particular, in a preferred but not binding manner, each one of the semi-rigid padding tiles 8 has a thickness equal to a range of 2÷4 mm, preferably 3 mm.

Still in particular, the water-repellent reflective fabric of the upper reinforcement layer is coloured and has a colour similar to the aluminium's.

Therefore, in the light of the materials used for constructing the various multilayer covering sections, what is obtained is an extreme lightness of the improved folding device of the invention, despite the considerable surface extension of the device, when it is in the application position or while it is being unfolded to be placed in such a position (that coincides with the operational condition of the multilayer element 2).

With regard to the locking means 4, they are arranged along the perimeter of each one of the multilayer covering sections 3 in such a way as to define, between the multilayer covering sections 3, the longitudinal interstitial discharge recesses 5: this application takes place after that the various multilayer covering sections, during the construction of the improved folding device 1 of the invention, were at least positioned in a predetermined position and associated to the above described various layers of fabric.

In particular, the semi-rigid padding tiles 8 are inserted into the internal pockets, that are not visible, and created in the lower layer 7 of each one of the multilayer covering sections 3 and closed by means of rapid coupling means, such as for example Velcro®.

In a preferred, however non-limiting way, the locking means 4 comprise any of the systems of mutual fixing of components—the fixed and not removable ones—selected from the group consisting of a seam portion, a heat-sealed portion, a glued portion, their combinations thereof and/or the like.

So, in an optional and not exclusive way, the multilayer element 2 is provided, in at least one of the multilayer covering sections 3 (in general, in two of them) positioned along only one of the first longitudinal directions X, with a through slot (not shown in the figures of the attached drawings) built in the thickness of the multilayer element 2 starting from one of its side edges having a shorter length 2a.

More in particular, the through slot is, as a rule, created in the multilayer covering sections element 3, which are arranged along the first longitudinal central direction X and coincide with the symmetry axis of the multilayer element 2 and, in the operational condition of the multilayer element, cover the rear window L and the rear end part of the car hood, when it constitutes the bulky body A.

The through slit allows the multilayer element 2 to be correctly and effectively positioned in its operational condition, above the bulky body A, even if an element protruding upwards from the bulky body A is present (for example, if a receiving antenna is present and applied to the car hood).

Preferably but not exclusively, the improved folding device 1 of the invention also comprises a containment folding box, which is not shown in the following figures, steadily associated to the lower face of one of the multilayer covering sections 3, and suitable to take the operational position when the multilayer element 2 is in its non-operational condition and creates the orderly and compact package 6 composed by the multilayer covering sections 3 (that are generally shaped as a parallelepiped) and which is steadily housed inside it.

However, when the multilayer element 2 takes on the operational condition, the containment folding box is in the rest position, stretched out and substantially positioned close to the lower wall of the multilayer covering section to which it is associated, in such a way as to take up the least possible space.

Therefore, when the multilayer element 2 is completely folded on itself (non-operational condition), it is hermetically housed in this containment folding box, where it can be locked by means of quick connection systems (such as Velcro®), associated with side bands coupled to the containment box, which allows to solve the problem of storing—and thus physically isolate from the neighbouring structures—the improved folding device 1 of the invention, especially when it is soaked with rain or wet because of atmospheric events.

Advantageously, although optionally, the containment folding box is coupled to at least one of the multilayer covering sections 3, having a higher surface extension and on which all the remaining multilayer covering sections 3 fold when changing from the operational condition to the non-operational condition of the multilayer element 2 and are arranged at the top when the multilayer element 2 changes from the operational condition to the non-operational condition.

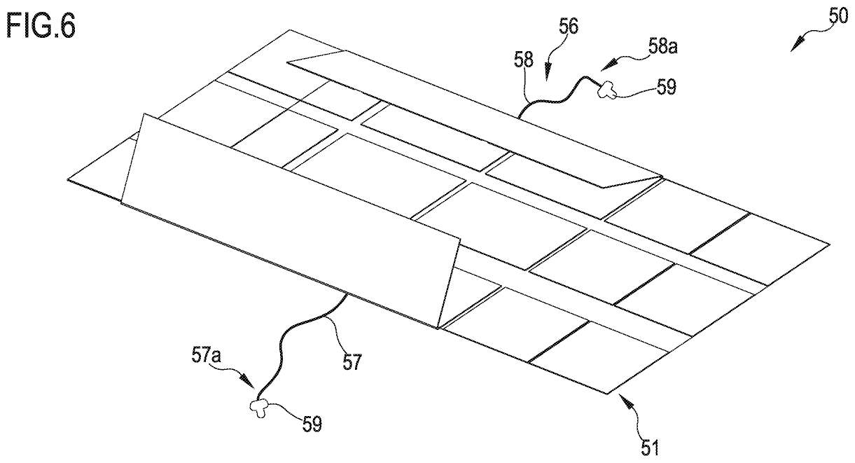

FIG. 6 shows a first possible variant embodiment of the invention in which the improved folding device herein exclusively claimed, and now generally designated by the reference numeral 50, differs from the previously described one, which is indicated by numeral 1, in that it also comprises anti-shoplifting means that are generally indicated by numeral 56, operatively connected to the multilayer element 51 and suitable to be steadily coupled to the bulky and three-dimensional body A when the multilayer element 51 takes on the operational condition, and they are thus not accessible from the outside.

The anti-shoplifting means 56, in addition to completely and fully prevent the improved folding device 50 from possibly and forcibly being removed from the bulky body A by criminals, while being in its operational condition, and positioned over the bulky body, also contribute to substantially increase the stability of the multilayer element 51 in its operational condition and to prevent accidental separation or incorrect positioning—misaligned with respect to the bulky body A, e.g. if strong wind blows—from occurring.

Typically, although only preferably, the anti-shoplifting means 56 comprise, in this case, two laminar belts 57, 58a, opposite to each other, each one of which is made of a cut resistant material and provided at a first end 57a, 58a—the one that remains free in the non-operational condition of the multilayer element 51—with a coupling pin 59 that snaps into position in an engagement grip P, which is located inside the bulky body A.

The laminar belts 57, 58 protrude each one from the longer side edges 51b, 51c of the multilayer element 51, in such a way as they are easily insertable from opposite sides inside the bulky body A (generally inside the car cabin, as it has already been mentioned).

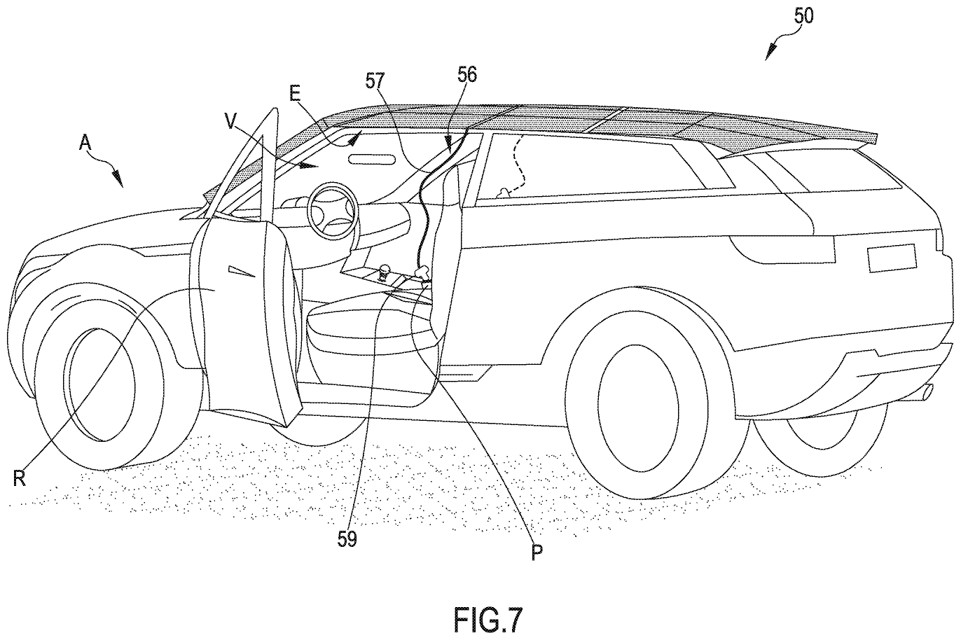

In practice, when the bulky body A is constituted by a car (as shown in FIG. 7), the laminar belts 57, 58 are inserted into the cabin of the car by going through the compartments V of the front doors R opposite to each other and are engaged with their own coupling pins 59 to the engagement grips P that are already available, and to which safety belts of the car A are normally attached and intended for the driver and the front passenger.

After being attached to the engagement grips P, the cut resistant laminar belts 57, 58 are still suitably pressed into position between the front door R seals and the frame E of the bodywork of the car A when the front doors R are closed: this guarantees a very reliable engagement system thanks to which the—forced or accidental—removal of the improved folding device 50 of the invention is really difficult and complicated even for criminals. In other variant embodiments of the improved folding device of the invention, which are not shown in the attached figures, anti-shoplifting means may comprise a number of laminar belts different from what has been indicated above, since this number may vary starting from one and up to, in general, the maximum value of four (as many as there are passenger doors in a car).

Moreover, if the improved folding device that is herein claimed is intended to cover a car, other embodiment solutions of the invention, that are again not shown in the enclosed drawings, may provide in that the anti-shoplifting means also include coupling ties, that are commonly freely associated to the longer lateral edges of the multilayer element and adapted to be tied around the front and/or rear door handles.

The number of such coupling ties will then depend on constructional choices and/or the needs of the market or the car, which the improved folding device of the invention for temporary covering a car, is intended for.

In further embodiments of the improved folding device of the invention for temporary covering a bulky body, such as a car, that are again not shown in the accompanying drawings, one or more of the multilayer covering sections of the multilayer element may comprise, on the upper face, a photovoltaic panel suitable for producing electrical energy to be stored in a battery associated with the car and intended for direct use—while the multilayer element takes on its operational condition—to heat or cool the covered and protected bulky body; or it may be intended for indirect use—while the multilayer element takes on the non-operational condition—to provide the car with the electric traction, lighting and/or the like.

From a practical and functional point of view, the improved folding device 1 of the invention initially takes on the non-application position, wherein the multilayer element 2 that characterises it, is in the non-operational condition, i.e. it is fully folded on to itself and creates the orderly and compact package 6, even better if it is inside the containment folding box integral to it: in this condition (see position S of FIG. 3), the improved folding device 1 of the invention suitable for car A of FIG. 4 takes up the least possible space and can be easily stored in the boot B of the car A, where it of a family, such as shopping bags.

In particular, in said non-operational condition, the multilayer element 2 suitable for car A of FIG. 4 (of the widely widespread type) has a height equal to 12 cm, a length equal to 68÷ 70 cm and a width equal to 42 cm, with a total weight not exceeding 3 kg. What can be then clearly inferred is that the occupied space is the smallest possible occupied space, if not negligible, inside the storing area.

If necessary, when the motor vehicle A of FIG. 4 is parked outdoors, the user takes the improved folding device 1 of the invention out of the boot B and, if envisaged as in the case herein described, also out of the containment folding box and arranges it above the rear part S of the hood C of the car A, as symmetrically as possible to the main axis of development of the latter.

After that, by means of simple and quick unfolding manoeuvres, the user (by themselves and without any help from other people) first has the stacked multilayer covering sections 3 progressively rotate around the longitudinal lines K, going from the position S of FIG. 3 to the position P of FIG. 3, thus partially opening one first part of the multilayer element 2 of the improved folding device 1 of the invention.

Hereinafter, the user unfolds the multilayer covering sections 3 of the multilayer element 2, which is still mostly stacked, and has them rotate around the latitudinal lines W and towards the front part N of the car A, by going from position O of FIG. 3 to position F of FIG. 3 and thus covering the car hood C and the front window T of the car A.

Finally, the user rotates the remaining multilayer covering sections 3, those that are still overlapping onto each other, around other longitudinal lines K, parallel to those around which the multilayer covering sections 3 were initially rotated during the initial steps of the opening of the multilayer element 2 of the improved folding device 1 of the invention, by going from position E of FIG. 3 to position B of FIG. 3 and covering the side windows F of the car A.

The last manoeuvre that the user performs to fully open the multilayer element 2 of the improved folding device 1, until its maximum surface extension, can be inferred by observing positions B and A of FIG. 3 and consists in having the three multilayer covering sections 3 rotate around a latitudinal line W (parallel to the lines of the rotations that brought the multilayer element 2 from position O of FIG. 3 to position F of FIG. 3), but this time towards the rear end of the vehicle A: in such a way, the rear window L of the car A is covered and the application position of FIG. 4 of the improved covering device 1 of the invention is then obtained.

The progressive rotation of the multilayer covering sections 3 around the longitudinal lines K and the latitudinal lines W is obtained thanks to the longitudinal interstitial discharge recesses 5 generated by the application system of the locking or junction means 4; so, upon each rotation around said longitudinal lines K and latitudinal lines W, the involved multilayer covering sections 3, positioned along a given first longitudinal direction X or along a given second longitudinal direction Y, move integrally and simultaneously: the multilayer covering section 3 is grabbed and positioned by the user and it drags with it the other sections that are aligned to it.

The above described operating sequence for arranging the multilayer element 2 in its operational condition is performed in a reverse manner when the improved folding device 1 of the invention is no longer used: the movement sequence of the multilayer covering sections 3 is exactly the same as the one shown in FIG. 3 from position A (operational condition of the multilayer element 2) to position S (non-operational condition of the multilayer element 2).

As far as the operation of the improved folding device 50 of the invention is concerned, as shown in FIG. 6, its positioning on to the car A occurs in a manner completely equivalent to what was described for the improved folding device 1 of the invention.

The only difference concerns its application, which is more effective and stable, on to the motor vehicle A thanks to the anti-shoplifting means 56 that, when the coupling pins 59 have been inserted into the engagement grips P inside the cabin of car A and the front doors R of the car A are closed, allow the improved covering device 50 to be safely fixed on to the car A and to become burglar-proof.

On the basis of the above description, what is therefore clear is that the improved covering device to temporarily cover bulky and three-dimensional bodies, achieves the objects and obtains the above-mentioned advantages.

The improved folding device for temporarily covering bulky and three-dimensional bodies of the invention can be positioned according to the application conditions and can be folded when at rest or not in use in a very effective, quick and simple way if compared to the known devices equivalent to it.

The manoeuvre can be effectively performed, even if not by one person only, and not necessarily a skilled person or an adult, because of its low weight and easy operation that goes with the improved folding device used for temporarily covering the bulky and three-dimensional bodies of the invention.

At the end of the folding operation (or closure), the improved folding device for the temporary cover of bulky bodies of the invention takes on a definitely more orderly and compact position with respect to similar devices of the prior art, with all the correlated advantages, especially as for its storage.

It should be noted that many different versions of the improved folding device according to the present invention used for covering bulky bodies, are produced having different sizes, and this due to the type and size of the bulky body to be covered and protected for which the device is intended.

In this regard, in further constructional solutions that are not shown, the improved folding device of the invention for covering bulky bodies may be intended to cover and protect the entire surface of the bulky body, when the multilayer element that characterises it, takes on its operational condition, for example the whole body of a car. In addition, the improved folding device of the invention used for temporarily covering the bulky bodies may include advertising signs or messages, positioned onto the upper surface of one or more of the multilayer covering sections of the multilayer element, in particular on the upper face of the upper layer made of water repellent reflective fabric, thus making it interesting for commercial companies too.

Finally, what is clear is that numerous other variants may be made to the improved folding device for said covering bulky bodies, without departing from the innovative principles inherent in the invention, just as it is clear that in the practical implementation of the invention, materials, shapes and sizes of the details illustrated may be different according to the requirements and may be substituted with other technically equivalent elements.

Where the constructional features and techniques mentioned in the following claims are followed by reference numerals or marks, these numerals or marks are intended to improve the intelligibility of the claims only, and consequently they have no limiting effect on the interpretation of each element identified, by way of example, by these reference numerals.

1. Improved folding device (1; 50) for covering bulky members (A) characterized in that it comprises a multilayer element (2; 51) composed of a plurality of multilayer covering sections (3) spaced apart, distinct and independent each other, firmly kept in position by locking means (4) placed in such a manner as to define among said multilayer covering sections (3) longitudinal interstitial lightening recesses (5) suitable to allow mutual rotation of said multilayer covering sections (3) along a plurality of longitudinal lines (K) parallel each other and along a plurality of latitudinal lines (W) parallel each other, orthogonal to and intersecting said longitudinal lines (K), in such a way that said multilayer element (2; 51) takes:
an operative condition suitable for the covering of at least the most critical and sensitive points of a bulky member (A) for its protection from invasive weathering, in which said multilayer covering sections (3) are substantially coplanar each other and placed side by side along first longitudinal directions (X) parallel each other and along second longitudinal direction (Y) parallel each other, orthogonal to the first longitudinal directions (X);
a non-operative condition suitable for the storing of said multilayer element (2; 51), in which said multilayer covering sections (3) are folded one on another according to a predefined sequence along said longitudinal lines (K) and said latitudinal lines (W), in such a manner that inner face of the multilayer covering sections (3) progressively affected by the bending are substantially placed close and facing to the inner face of the multilayer covering sections (3) on which they are folded and that said multilayer covering sections (3) are thus stacked and superimposed one on another forming a neat and compact packet (6).

2. Device (1; 50) according to claim 1), characterized in that the width dimension of each of said longitudinal interstitial lightening recesses (5) lying in one of said longitudinal lines (K) or in one of said latitudinal lines (W) is not less than the sum of the thickness of said multilayer cover sections (3) adjacent to it and undergone by the user to said folding for rotation around said longitudinal lines (K) or said latitudinal lines (W).

3. Device (1; 50) according to claim 1) characterized in that longitudinal interstitial lightening recesses (5) lying in one of said longitudinal lines (K) or in one of said latitudinal lines (W) present equal width dimension (L1, L2).

4. Device (1; 50) according to claim 1, characterized in that the length dimension of one of said multilayer cover sections (3), taken as reference, is lower than the length of one of said multilayer covering sections (3) on which said multilayer cover section of reference (3) is directly folded along said first longitudinal directions (X).

5. Device (1; 50) according to claim 1, characterized in that in the direction of the main longitudinal development of said multilayer element 51), suitable to correspond to the direction of the main longitudinal development of said bulky body (A) to be protected, the bending sequence of said multilayer covering sections (3) takes place according to an ascending order of the length of each of said multilayer covering sections (3).

6. Device (1; 50) according to claim 1, characterized in that, in said non-operative condition of said multilayer element (2; 51):
each of said multilayer covering sections (3) lying along one of said first longitudinal directions (X) is totally contained within the overall dimensions of one of said multilayer covering sections (3) adjacent to it along said first longitudinal direction (X) and above which it is folded, facing and arranged substantially behind;
each of said multilayer cover sections (3) lying along one of said second longitudinal directions (Y) is totally contained overall size of one of said multilayer cover sections (3) adjacent to it along said second longitudinal direction (Y) and above which it is folded, facing and placed substantially close to.

7. Device (1; 50) according to claim 1, characterized in that said multilayer covering sections (3) lying along one of said first longitudinal directions (X) or along one of said second longitudinal directions (Y) are movable jointly each other during said bending from said non-operative condition to said operative condition and vice versa and obtained by rotation of said multilayer covering sections (3) around one of said longitudinal lines (K) or one of said latitudinal lines (W).

8. Device (1; 50) according to claim 1, characterized in that said multilayer element (2; 51) comprises:
a lower layer (7) made of a soft scratch-resistant and water-repellent fabric, provided with a lower face (7a) suitable to contact said bulky member (A) to be protected;
a plurality of semi-rigid padding tiles (8), arranged above said lower layer (7) and made of insulating material, suitable to shield said bulky member (A) from said critical and invasive weathering and to adapt itself to the shape of said bulky member (A) to be protected;
an upper layer (9) made of reflective water-repellent fabric, arranged above said semi-rigid padding tiles (8) and provided with an upper face (9a) facing outwardly and suitable to be hit or affected by said critical and invasive weathering, said lower layer (7), said semi-rigid tiles (8) and said upper layer (9) being made integral each other by said locking means (4).

9. Device (1; 50) according to claim 8), characterized in that said multilayer element (2; 51) comprises a layer of thermally insulating material (10) interposed between said semirigid tiles (8) and said upper layer (9), made integral with said lower layer (7), said semi-rigid tiles (8) and said upper layer (9) by said locking means (4).

10. Device (1; 50) according to claim 8), characterized in that each of said semi-rigid tile (8) is composed of a lower reinforcement substrate, an amorphous intermediate layer, and an upper reinforcement layer having a thickness substantially equal to that one of said lower reinforcing substrate.

11. Device (1; 50) according to claim 1, characterized in that said locking means (4) are arranged on the perimeter of each of said multilayer covering sections (3) in such a way as to define between said multilayer covering sections (3) said longitudinal interstitial lightening recesses (5).

12. Device (1; 50) according to claim 1, characterized in that said locking means (4) comprise any one of the fixed and non-removable mutual components fastening systems selected from the group consisting of seam, heat sealing, gluing stretch, their combinations and/or the like.

13. Device (1; 50) according to claim 1, characterized in that said multilayer element (2; 51) presents, in at least one of said multilayer covering sections (3) arranged along only one of said first longitudinal directions (X), a through slot made in the thickness of said multilayer element (2) starting from a side shorter length edge (2a) and suitable to allow to properly and effectively position said multilayer element (2; 51) in said operative condition, above said bulky member (A), even in presence of a protruding element from said bulky member (A).

14. Device (1; 50) according to claim 1, characterized in that it comprises a collapsible housing box, stably associated with the lower face of one of said multilayer covering sections (3), and suitable to take the working position when said multilayer element (2; 51) takes said non-operative condition in order to stably receive said neat and compact packet (6) of said multilayer covering sections (3).

15. Device (1; 50) according to claim 14), characterized in that said collapsible housing box is coupled with at least one of said multilayer covering sections (3) having higher surface extension and on which all of the remaining ones of said multilayer covering sections (3) are folded in the passage from said operative condition to said non-operative condition and are arranged above in said non-operative condition of said multilayer element (2; 51).

16. Device (50) according to claim 1, characterized in that it comprises anti-theft means (56) operatively connected with said multilayer element (51) and suitable to be stably coupled with said bulky member when said multilayer element (51) takes said operative condition resulting not accessible from the outside and increasing the stability of said multilayer element (51) in said operative condition and ensuring the substantial immovability and the impossibility of forcibly removing said multilayer element (51) from the outside.

17. Device (50) according to claim 16), characterized in that said anti-theft means (56) comprise at least one laminar belt (57, 58) made of cut-resistant material and provided at a first end (57a, 58a), that one which remains free in said non-operative condition of said multilayer element (51), with a hooking pin (59) which is snap-fitted into a coupling socket (P) present inside said bulky member (A).

18. Device according to claim 1), characterized in that one or more of said multilayer covering sections of said multilayer element comprise a photovoltaic panel suitable to produce electrical energy to be stored in a battery associated with said bulky member and intended for a direct use while said multilayer element takes said operative condition, to heat or cool said covered bulky member, or for an indirect use, while said multilayer element takes said non-operative condition, to ensure electrical traction, lighting and/or similar.
